(19) United States
(12) Patent Application Publication
(10) Pub. No.: US 2026/0349633 A1
(43) Pub. Date: Nov. 5, 2026

(54) PRINT CONTROL DEVICE, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Masaki SUZUKI, Kanagawa (JP)

(21) Appl. No.: 19/636,989

(22) Filed: Apr. 2, 2026

(30) Foreign Application Priority Data
Apr. 30, 2025 (JP) 2025-075342

(51) Int. Cl. G06F 3/12; G06V 40/16

(52) U.S. Cl. CPC G06F 3/1252; G06F 3/1208; G06F 3/1256; G06V 40/161

(57) ABSTRACT

A print control device that can split a 360-degree circumferential image at an optimal position and can print split images on a small number of sheets. The print control device includes a memory device that stores instructions and a processor that executes instructions to calculate a required number of sheets N required for printing an input image based on its aspect ratio, split the input image into split images when N is plural, and generate print target images for printing the split images on sheets, respectively. When the input image is a 360-degree circumferential image and N is an even number, the input image is split into N+1 pieces of split images, and two split images at both ends in a predetermined direction in the input image are stitched such that both ends of the two split images in the predetermined direction are stitched to generate one print target image.

### BACKGROUND

### Field of the Technology

The aspect of the embodiments relates to print control devices, control methods therefor, and storage media storing control programs therefor, and particularly relates to a print control device, a control method thereof, and a storage medium storing a control program thereof that control to print a 360-degree circumferential image on a cut sheet.

### Description of the Related Art

In recent years, it is known that a digital camera, a smartphone, and the like function as a print control device that easily obtains printed matter from obtained image data. In addition, specifications of digital cameras are diversified, and there is a 360-degree digital camera that includes two or more wide-angle lenses and is capable of shooting a 360-degree omnidirectional image. A 360-degree omnidirectional image shot by the 360-degree digital camera is often utilized for VR (Virtual Reality), but it is also possible to clip a landscape of 360-degree entire circumference centered on the 360-degree digital camera as a plane image.

When a plane image is clipped from a 360-degree omnidirectional image as is, distortions of upper and lower parts of the clipped plane image increase. Therefore, in many cases, a plane image is clipped after trimming upper and lower parts of the 360-degree omnidirectional image. Hereinafter, a plane image clipped after trimming upper and lower parts of a 360-degree omnidirectional image is referred to as a 360-degree circumferential image.

Since a 360-degree circumferential image includes a landscape of 360-degree entire circumference, it is usually a long image having a large aspect ratio. Therefore, as disclosed in Japanese Patent Laid-Open Publication No. 2002-187300, it is possible to print long printed matter matching a size of a 360-degree circumferential image by continuously printing on a roll sheet.

However, what is widely popular as a printer for home use is a printer that prints on a cut sheet. When attempting to print a 360-degree circumferential image using a printer that prints on a cut sheet, there is a problem that there is a large difference in an aspect ratio between the 360-degree circumferential image and the cut sheet.

Here, when an upper and lower trimming amount is adjusted to match a 360-degree circumferential image with an aspect ratio of a cut sheet, distortion of an image generated when forming a plane image becomes large, which is not desirable. Therefore, when printing a 360-degree circumferential image with a printer that prints on a cut sheet widely popular at home, it is necessary to split the 360-degree circumferential image into a plurality of images and print them.

Problems in splitting and printing a 360-degree circumferential image are described below with reference to FIGS. 7A-7G. FIG. 7A is an example of a cut sheet that has a vertical length H and a horizontal length W. FIG. 7B shows an example of a 360-degree circumferential image. When the 360-degree circumferential image is printed so as to match its vertical length with the vertical length H of the cut sheet, a horizontal length W1 becomes larger than the horizontal length W of the cut sheet. Accordingly, it is necessary to split the 360-degree circumferential image when printing on the cut sheet. When the 360-degree circumferential image is split into two parts of an equal size as shown in FIG. 7C, the horizontal length W2 is smaller than the horizontal length W of the cut sheet, so that the images can be printed on two cut sheets as shown in FIG. 7D. Hatched portions in the drawing are margins.

However, when the 360-degree circumferential image is split as shown in FIG. 7C, a split line overlaps a subject that is a part of persons, so the subject is separated. In order to prevent the subject as a person and the split line from overlapping, it is necessary to move the split line to a position avoiding the subject. For example, as shown in FIG. 7E, a method is conceivable in which the split line is shifted to the left from a position in FIG. 7D so that a left split image has a horizontal length W3 (< W2) and a right split image has a horizontal length W4 (> W2). But because the horizontal length W4 of the right split image is larger than the horizontal length W of the cut sheet, it is necessary to further split the right split image at a position not overlapping with the subject as a person. That is, it is necessary to split the image into three parts having horizontal lengths W3, W5, and W6 as shown in FIG. 7F. When the split three images are printed on the cut sheets, they can be printed without separating the subject as shown in FIG. 7G, but three cut sheets are required, and margins (hatched portions in the drawing) generated on the cut sheet become large.

### SUMMARY

A the present disclosure provides a print control device, a control method thereof, and a storage medium storing a control program thereof that can split a 360-degree circumferential image at an optimal position and can print split images on a small number of cut sheets.

Accordingly, an aspect of the embodiments provides a print control device including a memory device that stores a set of instructions; and at least one processor that executes the set of instructions to calculate a required number of sheets N required for printing an input image based on an aspect ratio of the input image, split the input image into split images in a case where the required number of sheets N is plural, and generate print target images for printing the split images on sheets, respectively, based on the split images, The at least one processor executes, when the input image is a 360-degree circumferential image and the required number of sheets N is an even number, instructions in the memory device to split the input image into N+1 pieces of split images, and stitch two split images at both ends in a predetermined direction in the input image among the N+1 pieces of split images such that both ends of the two split images in the predetermined direction in the input image are stitched to generate one print target image.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view describing a configuration of a printer as a print control device according to an embodiment of the present disclosure.

FIG. 2 is a block diagram showing a hardware configuration of the printer according to the embodiment of the present disclosure.

FIG. 3 is a diagram showing a size of a paper sheet according to the embodiment of the present disclosure.

FIG. 4 is a flowchart showing a procedure of a print image generation process according to the embodiment of the present disclosure.

FIG. 5A is a diagram describing a method for generating a 360-degree circumferential image according to the embodiment of the present disclosure.

FIG. 5B is a diagram describing a method for splitting a 360-degree circumferential image according to the embodiment of the present disclosure.

FIG. 5C is a diagram describing a method for generating a stitched image according to the embodiment of the present disclosure.

FIGS. 6A and 6B are diagrams describing printed matter on which image data is printed according to the embodiment of the present disclosure.

FIGS. 7A-7G are diagrams describing conventional examples.

### DESCRIPTION OF THE EMBODIMENTS

Hereinafter, embodiments of the present disclosure will be described in detail with reference to the attached drawings.

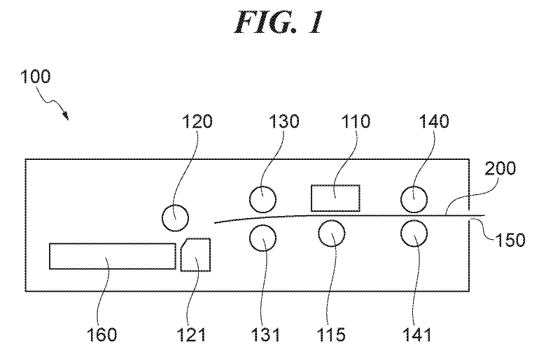

FIG. 1 is a cross-sectional view describing a configuration of a printer 100 as a print control device according to an embodiment of the present disclosure. Note that the print control device according to the embodiment of the present disclosure is not limited to the printer 100 itself as long as it is an apparatus that can control the printer 100 to split a long image including a 360-degree circumferential image and print it on cut sheets 200. For example, the print control device according to the embodiment of the present disclosure may be a smartphone capable of wireless communication with the printer 100, or may be a PC connected to the printer 100 via a LAN.

As shown in FIG. 1, the printer 100 includes a printing unit 110, a platen roller 115, a sheet feed roller 120, a separation unit 121, a conveyance roller 130, a conveyance driven roller 131, a discharge roller 140, a discharge driven roller 141, a discharge port 150, and a sheet feed unit 160.

The sheet feed unit 160 stores cut sheets inside the printer 100. The sheet feed roller 120 supplies a cut sheet 200 from the sheet feed unit 160 toward the printing unit 110.

The printing unit 110 is controlled based on print data generated by a CPU 101 described later, and can print images and characters by applying ink to the cut sheet 200.

The platen roller 115 is rotatably arranged in the printer 100 and is configured to rotate in accordance with conveyance of the cut sheet 200.

The sheet feed roller 120, the conveyance roller 130, and the discharge roller 140 are rotationally driven by a drive source (not shown).

The conveyance driven roller 131 faces the conveyance roller 130 across the cut sheet 200 and rotates following rotation of the conveyance roller 130.

The discharge driven roller 141 faces the discharge roller 140 across the cut sheet 200 and rotates following rotation of the discharge roller 140.

The separation unit 121 can separate the top cut sheet by butting the cut sheet 200 and feed it to the printing unit 110.

The discharge port 150 is configured to discharge the cut sheet 200 to the outside of the printer 100.

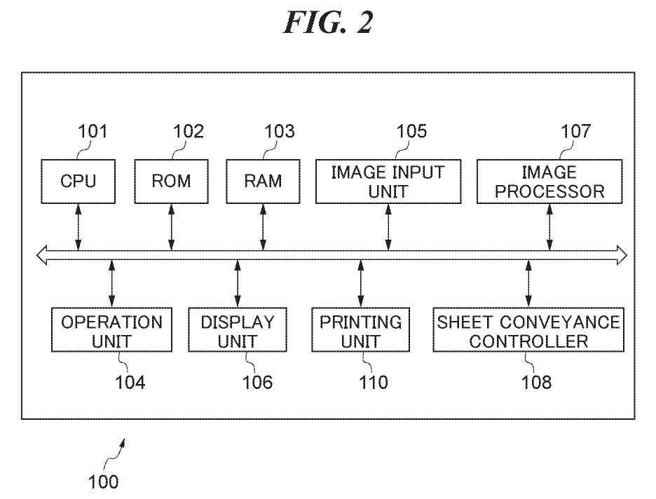

FIG. 2 is a block diagram showing a hardware configuration of the printer 100 according to the embodiment of the present disclosure. In FIG. 2, the printer 100 includes the CPU 101, a ROM 102, a RAM 103, an operation unit 104, an image input unit 105, a display unit 106, an image processor 107, a sheet conveyance controller 108, and the printing unit 110.

The CPU 101 controls the entire system of the printer 100. The ROM 102 is a nonvolatile memory such as a flash memory and stores programs in which operation procedures for the CPU 101 to execute various processes are described. The RAM 103 is used as a temporary working memory for the CPU 101.

The operation unit 104 is used to receive an operation to the printer 100 from a user. Operations here include, for example, power ON/OFF, selection of an image to be printed, a printing instruction, various setting changes of the printer 100.

The image input unit 105 can input image data to be printed into the printer 100. The image data input from the image input unit 105 is temporarily saved in the RAM 103.

The display unit 106 can display image data to be printed and an interface used when performing various settings.

The image processor 107 can split, as described later, the image data input by the image input unit 105 and temporarily stored in the RAM 103. Split image data is stored in the RAM 103 again.

The sheet conveyance controller 108 conveys the cut sheet 200 by controlling rotational driving of the sheet feed roller 120, the conveyance roller 130, and the discharge roller 140 shown in FIG. 1.

The printing unit 110 prints the image data temporarily saved in the RAM 103 on the cut sheet 200 conveyed by the sheet conveyance controller 108 based on control of the CPU 101.

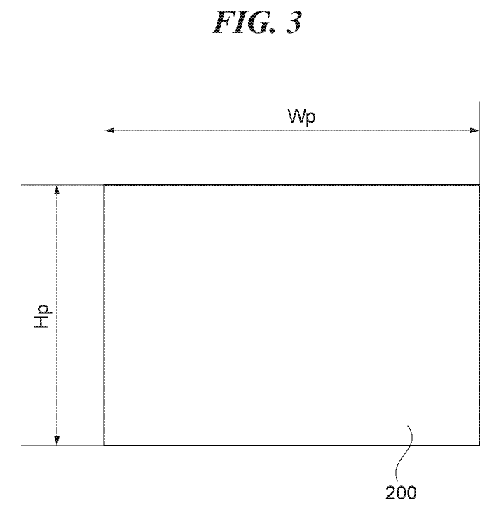

FIG. 3 is a diagram showing a size of the cut sheet 200 according to the embodiment of the present disclosure. As shown in FIG. 3, the cut sheet 200 has a vertical length Hp and a horizontal length Wp. The cut sheet 200 has a rectangular shape in which the horizontal length Wp is longer than the vertical length Hp.

Next, operations of a print image generation process of the printer 100 is described with reference to FIGS. 3-6.

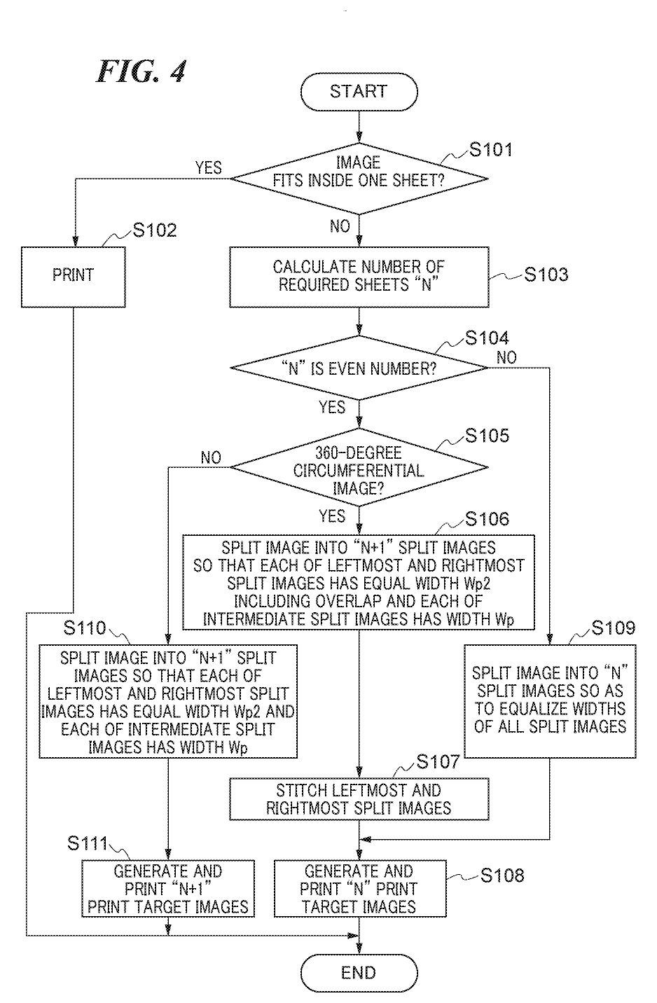

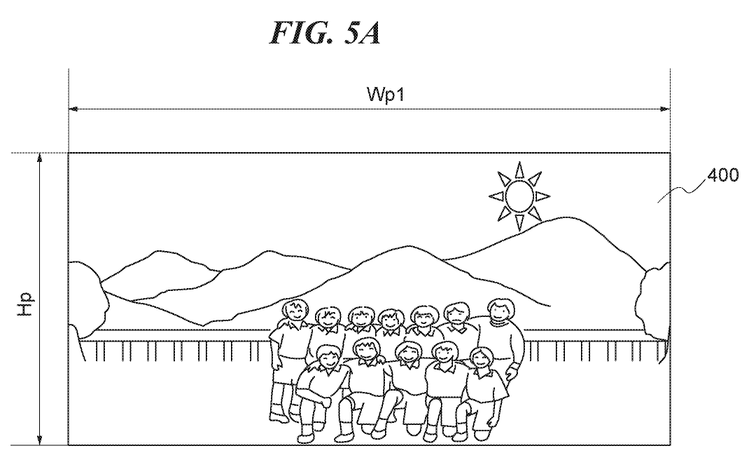

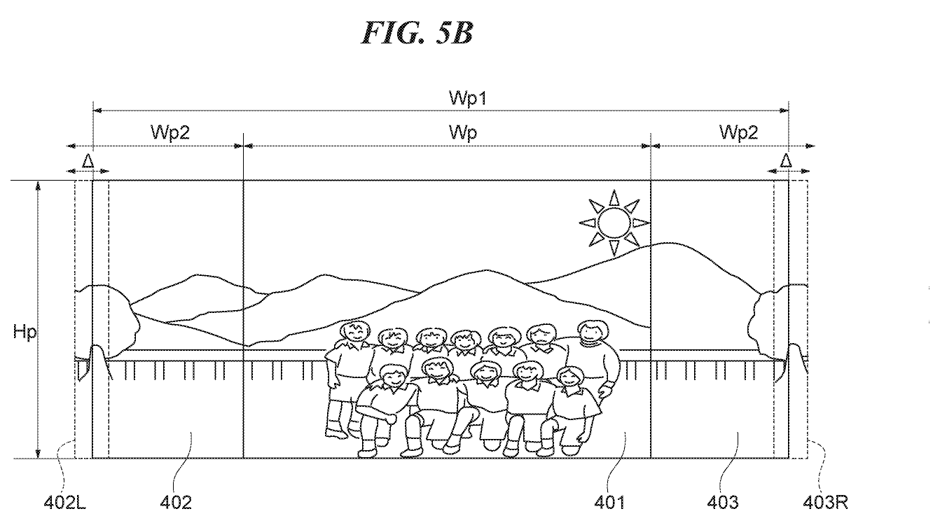

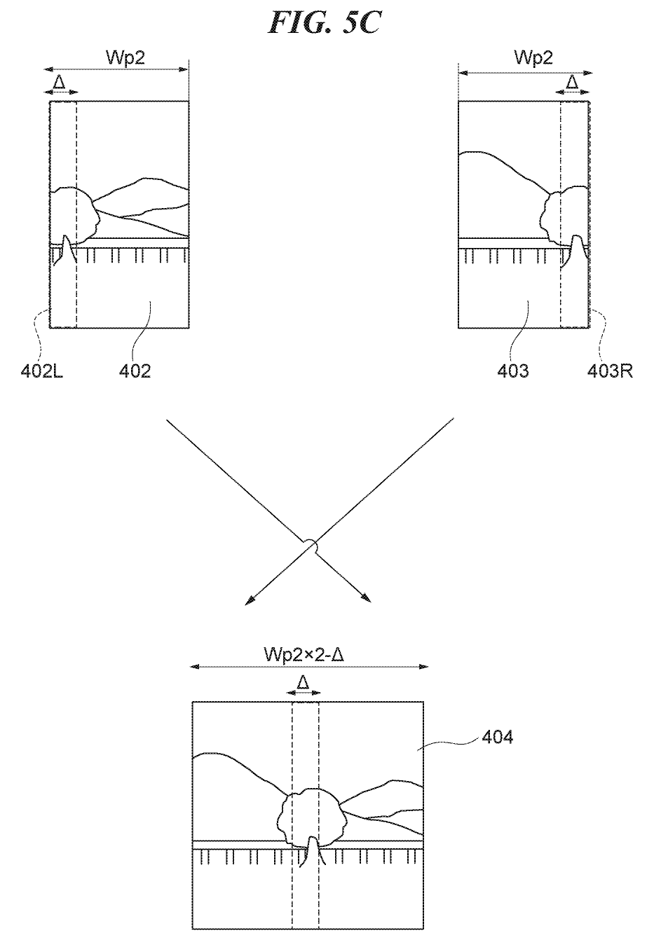

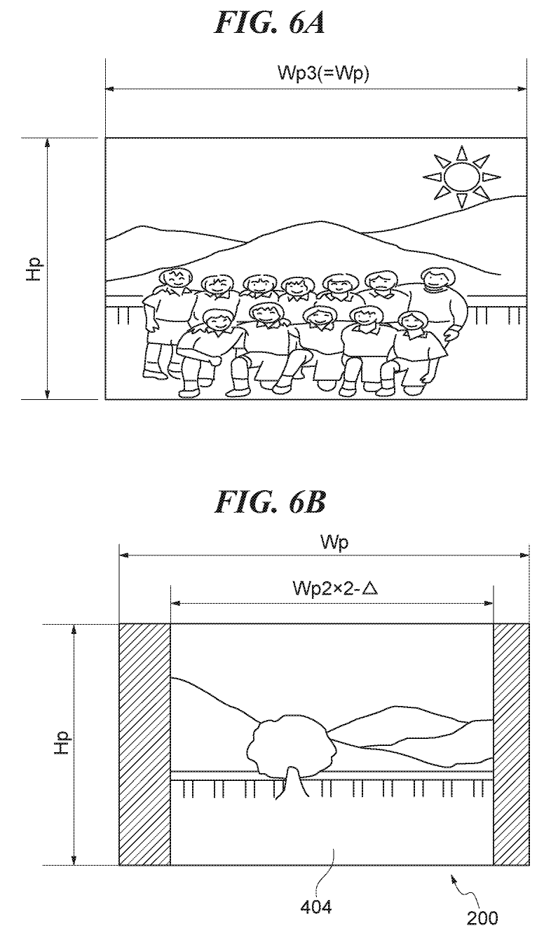

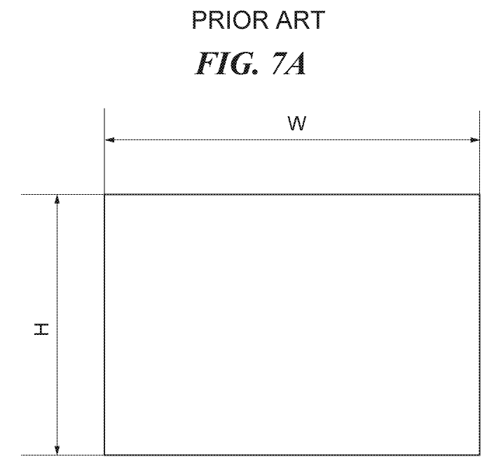

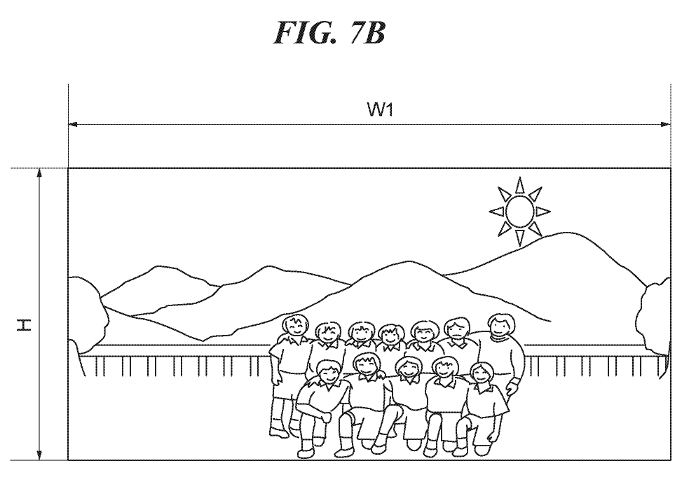

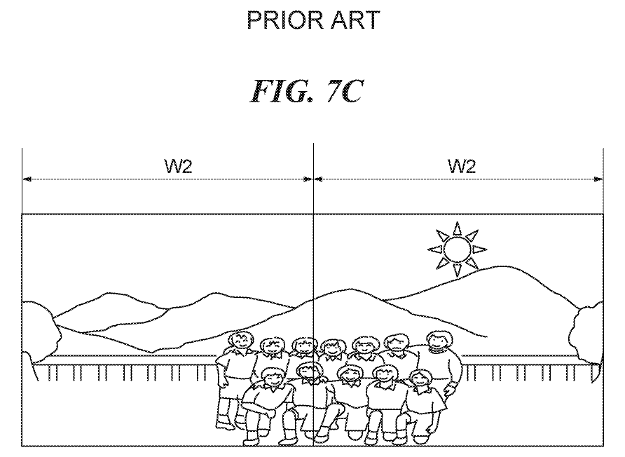

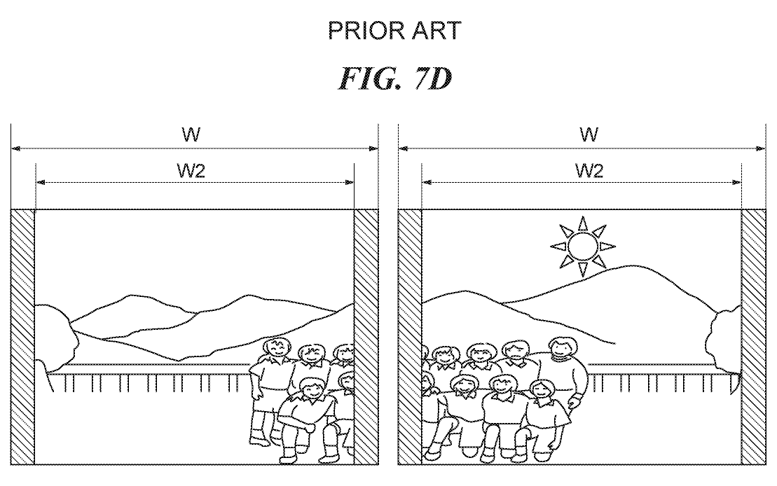

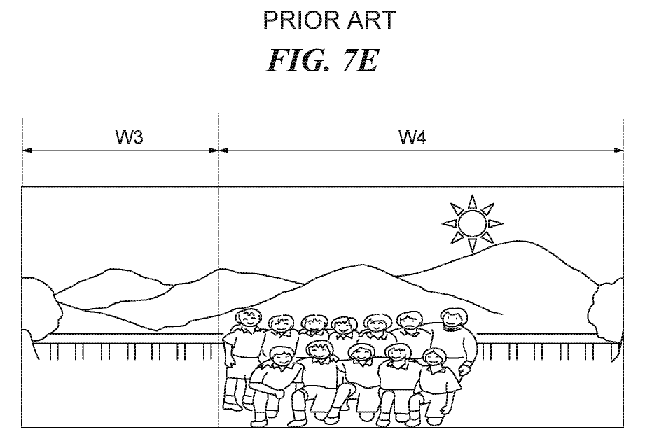

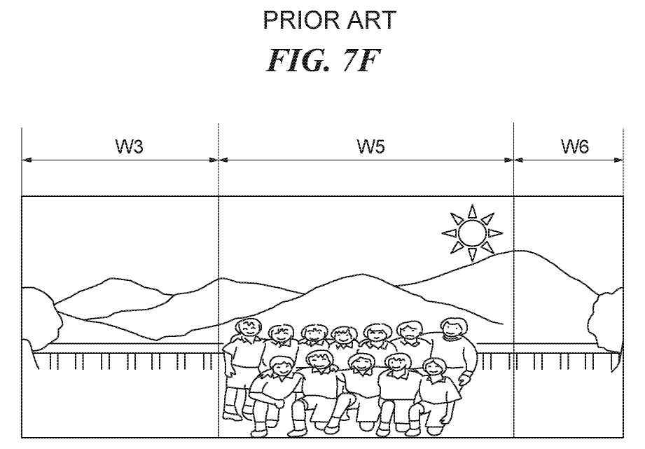

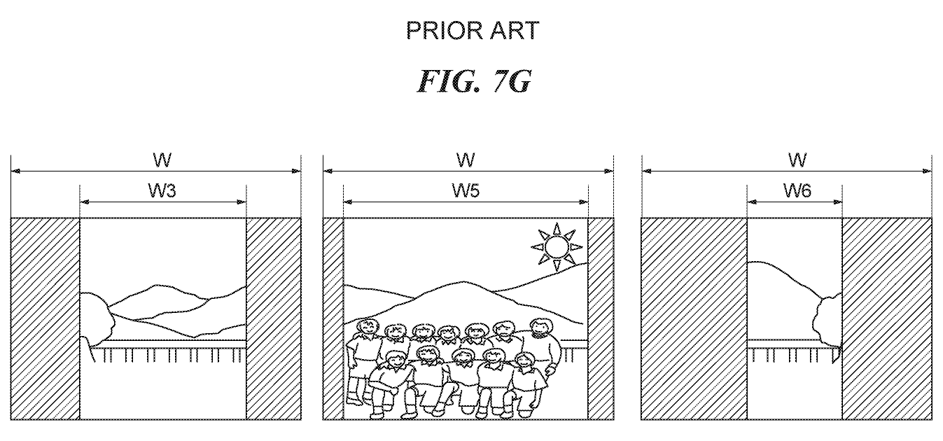

FIG. 4 is a flowchart showing a procedure of a print image generation process according to the embodiment of the present disclosure. FIGS. 5A-5C are diagrams describing a specific example of a print image generation process according to the embodiment of the present disclosure. Further, FIGS. 6A and 6B are diagrams describing a printed matter on which the image data is printed according to the embodiment of the present disclosure.

The print image generation process is executed by the CPU 101 developing the program stored in the ROM 102 into the RAM 103. This process starts when the image input unit 105 submits image data of an input image 400 to the image processor 107.

First, the CPU 101 determines whether the input image 400 can be arranged within one cut sheet 200 without splitting (whether the input image fits into one cut sheet 200) in a step S101 on the basis of an aspect ratio of the input image 400. Specifically, the CPU 101 scales the input image 400 so as to match the vertical length of the input image 400 with the vertical length Hp of the cut sheet 200 as shown in FIG. 5A. Next, the CPU 101 determines whether a horizontal length Wp1 of the scaled input image 400 (hereinafter referred to as an image width Wp1) is equal to or less than the horizontal length Wp of the cut sheet 200 (hereinafter referred to as a sheet width Wp). When the image width Wp1 of the input image 400 is equal to or less than the sheet width Wp of the cut sheet 200, it is determined that the input image 400 fits inside one cut sheet 200 (YES in the step S101) and the procedure proceeds to a step S102. In the step S102, the input image 400 is printed without splitting, and this procedure ends. On the other hand, when the image width Wp1 of the input image 400 is longer than the sheet width Wp of the cut sheet 200, it is determined that the input image 400 does not fit into one cut sheet 200 (NO in the step S101), and the procedure proceeds to a step S103.

In the step S103, the CPU 101 calculates (determines) the required number of sheets N. Here, the required number of sheets N is obtained by rounding up a quotient of Wp1/Wp to a natural number.

In a step S104, the CPU 101 determines whether the required number of sheets N calculated in the step S103 is an even number. When the required number of sheets N is an even number (YES in the step S104), the procedure proceeds to a step S105. On the other hand, when the required number of sheets N is not an even number (NO in the step S104), the procedure proceeds to a step S109. Even when the input image 400 is a 360-degree circumferential image, when the required number of sheets N is an odd number, the determination result becomes NO in the step S104 and the procedure proceeds to the step S109.

In the step S109, the input image 400 is split into N pieces such that widths of all split images become equal, and the procedure proceeds to a step S108.

In the step S105, the CPU 101 determines whether the input image 400 is a 360-degree circumferential image. The CPU 101 determines whether it is a 360-degree circumferential image by comparing luminance distributions in a vertical direction in the drawing of a left end and a right end of the input image 400 shown in FIG. 5A and determining whether they match. When the luminance distributions match, it is determined that the input image 400 is a 360-degree circumferential image (YES in the step S105), and the procedure proceeds to a step S106. On the other hand, when luminance distributions do not match, it is determined that the input image 400 is not a 360-degree circumferential image but is a panoramic image (NO in the step S105), and the procedure proceeds to a step S110.

Note that in the present embodiment, a 360-degree circumferential image (input image 400) is generated in advance from a 360-degree omnidirectional image by a method as follows. First, a 360-degree omnidirectional image is displayed on the display unit 106, and a user is caused to specify a position to be a center position of a 360-degree circumferential image (input image 400). A 360-degree circumferential image (input image 400) is a plane image generated by trimming upper and lower parts of a 360-degree omnidirectional image and by clipping an area from the trimmed image so that left and right ends of the area are located at positions opposite to the user-specified center position.

In the step S110, the input image 400 (a panoramic image) is split into N+1 pieces of split images. At this time, among the split images, a leftmost split image and a rightmost split image are set to have an equal image width Wp2, and an image width of the other split images is set to Wp. Thereafter, in a step S111, N+1 pieces of print target images are generated by adding margins for pasting as necessary to N+1 pieces of the split images generated in the step S110, and each of the generated print target images is printed on the cut sheet 200. Thereafter, this procedure ends.

On the other hand, in the step S106, the input image 400 (a 360-degree circumferential image) is split into N+1 pieces of split images. At this time, among the split images, a leftmost split image and a rightmost split image that are both ends in the horizontal direction are set to have an equal image width Wp2 including a margin for pasting, and an image width of the other split images is set to Wp. For example, when the required number of sheets N calculated in the step S103 is “2”, the input image 400 is split into three pieces including an intermediate split image 401, a leftmost split image 402, and a rightmost split image 403 in the horizontal direction (a predetermined direction) as shown in FIG. 5B.

The intermediate split image 401 has the image width Wp, and each of the leftmost split image 402 and the rightmost split image 403 has the image width Wp2 including a width Δ of the margin for pasting. As shown in FIG. 5B, the margins for pasting are provided at a left end 402L of the leftmost split image 402 and a right end 403R of the rightmost split image 403, respectively. In this way, when the required number of sheets N is an even number, a split count (the number of split images) of the input image 400 is set to be an odd number N+1. This is because the center position of the input image 400 is user-specified as described above, and thus a subject is often arranged, and when the split count is an even number, a split line is located at a center of the input image 400, and there is a high possibility that a split line overlaps with a person, an animal, or the like that is a subject. On the other hand, when the split count is an odd number, a split line is not located at a center of the input image 400, and thus it is possible to avoid overlapping of a subject and a split line.

Although the input image 400 is split so that the center of the intermediate split image 401 is located at the center of the input image 400 in the present embodiment, this is not limited. For example, when a face of a subject is split at a left end or a right end of the intermediate split image 401, the CPU 101 may adjust the center position of the intermediate split image 401 to shift from the center of the input image 400 so that the face of the subject is not split. In this case, the image width of the leftmost split image 402 and the image width of the rightmost split image 403 are set to different lengths. Note that this adjustment may be executed in response to a user operation by displaying the intermediate split image 401 on the display unit 106 so that the center position of the intermediate split image 401 can be changed by the user operation. In addition, the CPU 101 may execute this adjustment when performing image recognition of regions at a left end and a right end of the intermediate split image 401 and determining that a face of a subject is split in at least one of these regions as a result of the image recognition.

In addition, although the image width of the split images other than the leftmost split image and the rightmost split image among the split images is set to Wp in the present embodiment, the intermediate split image 401 may be displayed on the display unit 106 and its image width may be adjusted to be equal to or less than Wp (equal to or less than the sheet width) by a user operation. However, an adjustable range by a user operation is limited to a range in which an image width of a stitched image described later becomes equal to or less than Wp.

Returning to FIG. 4, a stitched image is generated by stitching the leftmost split image and the rightmost split image in a step S107. For example, when the required number of sheets N is “2”, a stitched image 404 is generated as shown in FIG. 5C. First, the leftmost split image 402 is arranged on a right side and the rightmost split image 403 is arranged on a left side. Next, the margins for pasting provided at the left end 402L of the leftmost split image 402 and the right end 403R of the rightmost split image 403 are overlapped and stitched. Accordingly, a continuous stitched image 404 is generated. Thereafter, the procedure proceeds to the step S108.

In the step S108, N pieces of print target images are generated by adding the margin for pasting as necessary so that the generated N pieces images are respectively printed on N pieces of the cut sheets 200, and N pieces of the print target images are printed. After printing, this procedure ends. Specifically, when the required number of sheets N is an odd number, the input image 400 is split into N pieces of split images whose widths are equal and these split images are set as the print target images and are printed on the cut sheets 200 in the step S109. On the other hand, when the required number of sheets N is an even number, the input image 400 is split into N+1 pieces of split images, and N-1 pieces of split images (image width Wp) other than the leftmost and rightmost split images and the stitched image generated in the step S107 are set as print target images and are printed on the cut sheets 200.

For example, when the required number of sheets N is 2, the intermediate split image 401 and the stitched image 404 are generated. Since the image width Wp3 of the intermediate split image 401 is the same as the sheet width Wp of the cut sheet 200, the intermediate split image 401 is arranged and printed on the cut sheet 200 without margins as shown in FIG. 6A. In addition, since the image width of the stitched image 404 is (Wp2×2-Δ) that is narrower than the sheet width Wp of the cut sheet 200, the stitched image 404 is arranged and printed on the cut sheet 200 with margins at the left and right sides as shown in FIG. 6B.

In this way, according to the procedure in FIG. 4, when the required number of sheets N is an even number, the leftmost split image 402 and the rightmost split image 403 generated in the step S106 are stitched to form one continuous image in the step S107. Accordingly, the number of the cut sheet 200 used when splitting and printing a 360-degree circumferential image can be reduced, and margins generated on the cut sheet 200 can also be made small.

In the above-mentioned embodiment, when the input image 400 is not a 360-degree circumferential image and the required number of sheets N is an even number, the image is split into N+1 pieces of split images. However, this increases the number of sheets. In addition, when the input image 400 is a mere panoramic image but not a 360-degree circumferential image, and particularly, when a panoramic image is obtained by stitching images subsequently shot from an edge with a swing panorama function, a main subject is not located at a center in many cases. Accordingly, when the input image 400 is not a 360-degree circumferential image, the input image 400 may be split into N pieces and printed as in the step S109 without switching the split number between N pieces and N+1 pieces depending on whether the required number of sheets is an odd number or an even number. Alternatively, it is detected whether a main subject is located at a center, and when the required number of sheets is an even number, the split count may be N+1 according to the detection result.

According to the present disclosure, when splitting a 360-degree circumferential image and printing it on a plurality of sheets of paper, it is possible to split it at an optimal position with a small number of sheets of paper.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-075342, filed Apr. 30, 2025, which is hereby incorporated by reference herein in its entirety.

What is claimed is:

1. A print control device comprising:
a memory device that stores a set of instructions; and
at least one processor that executes the set of instructions to:
calculate a required number of sheets N required for printing an input image based on an aspect ratio of the input image;
split the input image into split images in a case where the required number of sheets N is plural; and
generate print target images for printing the split images on sheets, respectively, based on the split images,
wherein the at least one processor executes, when the input image is a 360-degree circumferential image and the required number of sheets N is an even number, instructions in the memory device to:
split the input image into N+1 pieces of split images; and
stitch two split images at both ends in a predetermined direction in the input image among the N+1 pieces of split images such that both ends of the two split images in the predetermined direction in the input image are stitched to generate one print target image.

2. The print control device according to claim 1, wherein the at least one processor executes, when the input image is a 360-degree circumferential image and the required number of sheets N is an odd number, instructions in the memory device to:
split the input image into N pieces of split images; and
generate N pieces of print target images for respectively printing the N pieces of split images on N pieces of sheets.

3. The print control device according to claim 1, wherein the predetermined direction is a horizontal direction, and
the at least one processor executes instructions in the memory device to generate one print target image by arranging a rightmost split image on a left side and a leftmost split image on a right side among the plurality of split images and stitching both ends in the horizontal direction.

4. The print control device according to claim 1, wherein the at least one processor executes, when the input image is not a 360-degree circumferential image, instructions in the memory device to split the input image into N pieces regardless of whether the required number of sheets N is an even number.

5. The print control device according to claim 1, wherein the at least one processor executes instructions in the memory device to:
calculate an image width of the input image when scaling the input image so as to match a vertical length of the input image with a vertical length of the sheet; and
calculate the required number of sheets N required for printing the scaled input image based on a value obtained by rounding up a quotient obtained by dividing the calculated image width by a sheet width to a natural number.

6. The print control device according to claim 1, wherein the at least one processor executes instructions in the memory device to perform adjustment of a center position of an intermediate split image, which is located at a center of the input image among the split images, to shift from the center of the input image so that a face of a subject is not split at a left end or a right end of the intermediate split image.

7. The print control device according to claim 6, wherein the at least one processor executes instructions in the memory device to:
perform image recognition of a region at the left end or the right end of the intermediate split image; and
perform the adjustment when it is determined that a face of a subject is split in the region at the left end or the right end of the intermediate split image as a result of the image recognition.

8. The print control device according to claim 6, wherein the at least one processor executes instructions in the memory device to:
display the intermediate split image so that the center position of the intermediate split image can be changed by a user operation; and
perform the adjustment according to the user operation.

9. The print control device according to claim 6, wherein the at least one processor executes instructions in the memory device to display the intermediate split image so that an image width of the intermediate split image can be adjusted to be equal to or less than a sheet width by a user operation.

10. The print control device according to claim 1, wherein the 360-degree circumferential image is a plane image generated by clipping an area from a 360-degree omnidirectional image so that left and right ends of the area are located at positions opposite to a user-specified center position in the 360-degree omnidirectional image.

11. The print control device according to claim 10, wherein the 360-degree circumferential image is generated by clipping after trimming upper and lower parts of the 360-degree omnidirectional image.

12. A control method for a print control device, the control method comprising:
calculating a required number of sheets N required for printing an input image based on an aspect ratio of the input image;
splitting the input image into split images in a case where the required number of sheets N is plural; and
generating print target images for printing the split images on sheets, respectively, based on the split images,
wherein when the input image is a 360-degree circumferential image and the required number of sheets N is an even number,
the input image is split into N+1 pieces of split images; and
two split images at both ends in a predetermined direction in the input image among the N+1 pieces of split images are stitched such that both ends of the two split images in the predetermined direction in the input image are stitched to generate one print target image.

13. A non-transitory computer-readable storage medium storing a control program causing a computer to execute a control method for a print control device, the control method comprising:
calculating a required number of sheets N required for printing an input image based on an aspect ratio of the input image;
splitting the input image into split images in a case where the required number of sheets N is plural; and
generating print target images for printing the split images on sheets, respectively, based on the split images,
wherein when the input image is a 360-degree circumferential image and the required number of sheets N is an even number,
the input image is split into N+1 pieces of split images; and
two split images at both ends in a predetermined direction in the input image among the N+1 pieces of split images are stitched such that both ends of the two split images in the predetermined direction in the input image are stitched to generate one print target image.
